(19) United States
(12) Patent Application Publication
(10) Pub. No.: US 2003/0020726 A1
(43) Pub. Date: Jan. 30, 2003

(54) Method and system for displaying graphics information

(75) Inventor: Frederic Jean-Luc Charpentier, Ottawa (CA)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: BITFLASH GRAPHICS, INC., Gloucester (CA)

(21) Appl. No.: 10/183,562

(22) Filed: Jun. 28, 2002

Related U.S. Application Data
(60) Provisional application No. 60/301,423, filed on Jun. 29, 2001.
(60) Provisional application No. 60/301,482, filed on Jun. 29, 2001.

(51) Int. Cl. G09G 5/02

(52) U.S. Cl. 345/603

(57) ABSTRACT

Graphics information (such as text, icons, images, etc.) is modified from a received format to a format adapted for displaying the graphics information on a computing device. Modification of the graphics information is based on characteristics of the computing device that represent capabilities of a display of the computing device. The graphics information is generated in a module to convert the graphics information into a format that is suitable for display on the computing device. The module is accessed to obtain the graphics information therefrom. The graphics information is obtained from the module according to the characteristics of the computing device such that the obtained graphics information is in a format adapted for display on the computing device.

### CROSS REFERENCE TO RELATED APPLICATIONS

The present application claims priority from U.S. provisional patent application serial No. 60/301,423 filed on Jun. 29, 2001. U.S. patent application entitled “Method and System for Manipulation of Graphics Information” (Attorney Docket No. 225103US) was filed concurrently herewith and claims priority from U.S. provisional patent application serial No. 60/301,482 filed on Jun. 29, 2001. The entire contents of each of the above applications are incorporated herein by reference.

### FIELD OF THE INVENTION

The present invention is directed towards displaying graphics information on a computing device.

### BACKGROUND OF THE INVENTION

With the increasing diversity of computing devices capable of displaying graphics information there is an increased demand to provide such information in a format that can be interpreted by each computing device. This has resulted in the development of a wide variety of formats for graphics information and often the provision of a multiplicity of the graphics information for each format. The resulting format often presents itself differently when displayed on different computing devices due to the different mechanisms by which the graphics information may be displayed. This can result in inaccurate depictions on the computing device of the original graphics information.

### SUMMARY OF THE INVENTION

In accordance with one aspect of the present invention there is provided a method of modifying graphics information in a first format for display on a computing device having a set of display characteristics representing display capabilities of the computing device, said method comprising: generating the graphics information in a display replication module to provide the graphics information in a second format; and obtaining the graphics information in the second format from said display replication module according to an access scheme based on the set of display characteristics to convert the graphics information into a third format suitable for display on the computing device.

In accordance with another aspect of the present invention there is provided a method of modifying graphics information in a first format for display on a computing device having a set of display characteristics representing display capabilities of the computing device, said method comprising: segmenting the graphics information into a plurality of graphic elements, each of said plurality of graphic elements representing a displayable characteristic from the graphics information; generating each of said plurality of graphic elements in a display replication module to provide the graphics information in a second format; and obtaining the graphics information in the second format from said display replication module according to an access scheme based on the set of display characteristics to convert the graphics information into a third format suitable for display on the computing device.

In accordance with a further aspect of the present invention there is provided a system for modifying graphics information in a first format for display on a computing device having a set of display characteristics representing display capabilities of the computing device, said system comprising: a display replication module for retaining the graphics information in a second format that is interpretable by the computing device; an interpretation mechanism for generating the graphics information in said display replication module to provide the graphics information in the second format; a module access mechanism for obtaining the generated graphics information from said display replication module according to an access scheme based on the set of display characteristics to provide graphics information in a third format adapted for display on the computing device; and a controller for orchestrating conversion of the graphics information between the first format, the second format and the third format.

In accordance with yet another aspect of the present invention there is provided a computer readable medium having stored thereon computer-executable instructions for modifying graphics information in a first format for display on a computing device having a set of display characteristics representing display capabilities of the computing device, said computer-executable instructions comprising: generating the graphics information in a display replication module to provide the graphics information in a second format; and obtaining the graphics information in the second format from said display replication module according to an access scheme based on the set of display characteristics to convert the graphics information into a third format suitable for display on the computing device.

In accordance with an aspect of the present invention there is provided a computer readable medium having stored thereon computer-executable instructions for modifying graphics information in a first format for display on a computing device having a set of display characteristics representing display capabilities of the computing device, said computer-executable instructions comprising: segmenting the graphics information into a plurality of graphic elements, each of said plurality of graphic elements representing a displayable characteristic from the graphics information; generating each of said plurality of graphic elements in a display replication module to provide the graphics information in a second format; and obtaining the graphics information in the second format from said display replication module according to an access scheme based on the set of display characteristics to convert the graphics information into a third format suitable for display on the computing device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The present invention will be described in conjunction with the drawings in which:

FIG. 1 is a system diagram of a generic computing device in which the present invention may be implemented;

FIG. 2 is a system diagram of a system for adapting and displaying graphics information on a computing device according to an embodiment of the present invention;

FIG. 3 is a system diagram of a graphics interpretation mechanism of the system in FIG. 2; and

FIGS. 4A and B is a flow diagram representing a method of adapting and displaying graphics information according to an embodiment of the present invention.

### DETAILED DESCRIPTION

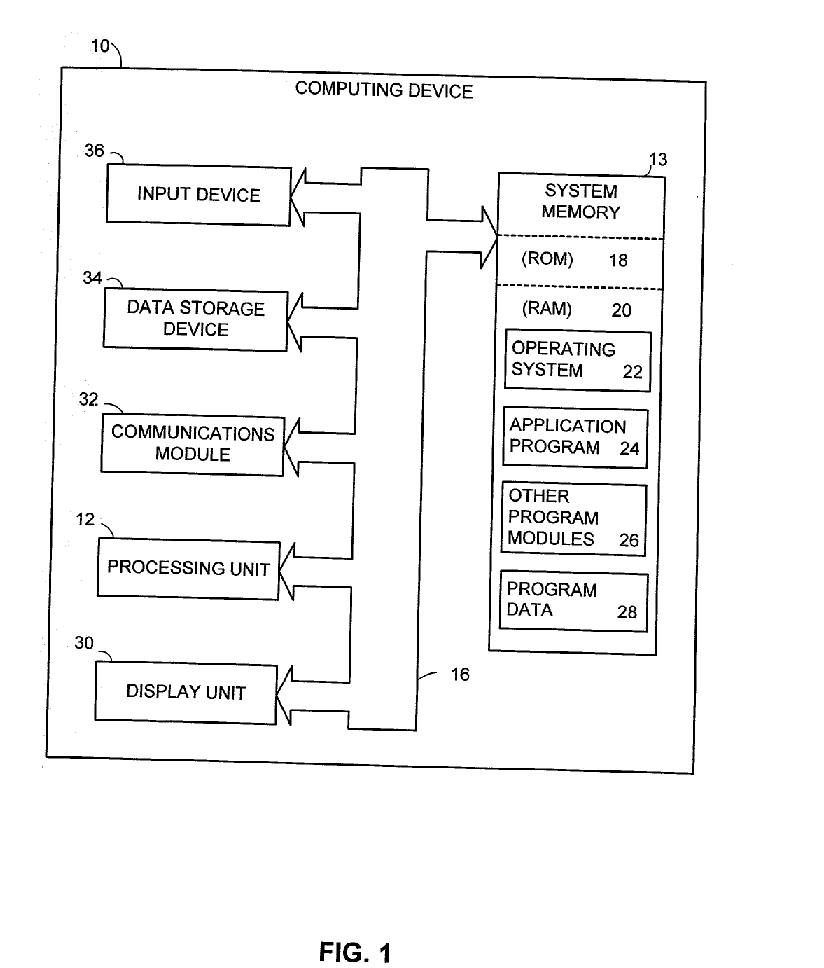

FIG. 1 and the associated description represent an example of a suitable computing device 10 in which the present invention may be implemented. While the invention will be described in the context of a single standalone computer program, the present invention can also be implemented, in whole or in part, in combination with other program modules. Generally, program modules include routines, programs, components, data structures and the like that perform particular tasks or implement particular abstract data types. Further, the present invention can also be implemented using or in combination with other computer system configurations, including hand-held devices, multiprocessor systems, microprocessor-based or programmable consumer electronics, minicomputers, mainframe computers, set-top boxes, appliances and distributed computing environments where program modules may be located in both local and remote memory storage devices.

With reference to FIG. 1, the present invention may be implemented within the computing device 10 in the form of a personal computing device such as, a personal digital assistant (PDA), electronic organizer, wireless telephone, two-way pager, conventional computer or embedded computing device. The computing device 10 includes a processing unit 12, a system memory 14, a communications module 32, a display unit 30 and a system bus 16 that couples various system components including the system memory 14 to the processing unit 12.

The system memory 14 includes read only memory (ROM) 18 and random access memory (RAM) 20. A number of program modules may be stored in the ROM 18 or RAM 20, including an operating system 22, one or more application programs 24, other program modules 26, and program data 28.

Commands and information may be entered into the computing device 10 through an input device 36. The input device 36 may include a keyboard, a pointing device, a stylus, a microphone, a joystick, etc.

A data storage device 34 connected to the system bus 16 can be one or more non-volatile, possibly removable, memory devices that are not directly addressable by the processing unit 12 such as solid-state drives (e.g. PC Card format memory cards) or rotating magnetic media drives (e.g. hard disk drives). The data storage device 34 includes the intermediary functions, such as drive controllers, to allow the processing unit 12 to access the data storage devices' contents.

The display unit 30 displays information from the system memory 14 or the data storage device 34. The display unit 30 may comprise one or more visual output devices such as a liquid crystal display (LCD), a light emitting diode (LED), or other similar type of display device.

The computing device 10 may operate in a networked environment via the communications module 32 using logical connections to one or more remote computing systems, such as a personal computer, a server, a router, a peer device or other common network nodes such as the system disclosed in co-pending U.S. patent application titled “Method and System for Manipulating Graphics Information” filed concurrently herewith, the contents of which are herein incorporated by reference. The communications module 32 interfaces with a logical connection that may include both wireless and wireline networks such as a local area network (LAN) a wide area network (WAN), the Public Switched Telephone Network (PSTN) or Public Land Mobile Network (PLMN), providing protocol support, buffering, processing and control functions to support data communications between the computing device 10 and the logical connection.

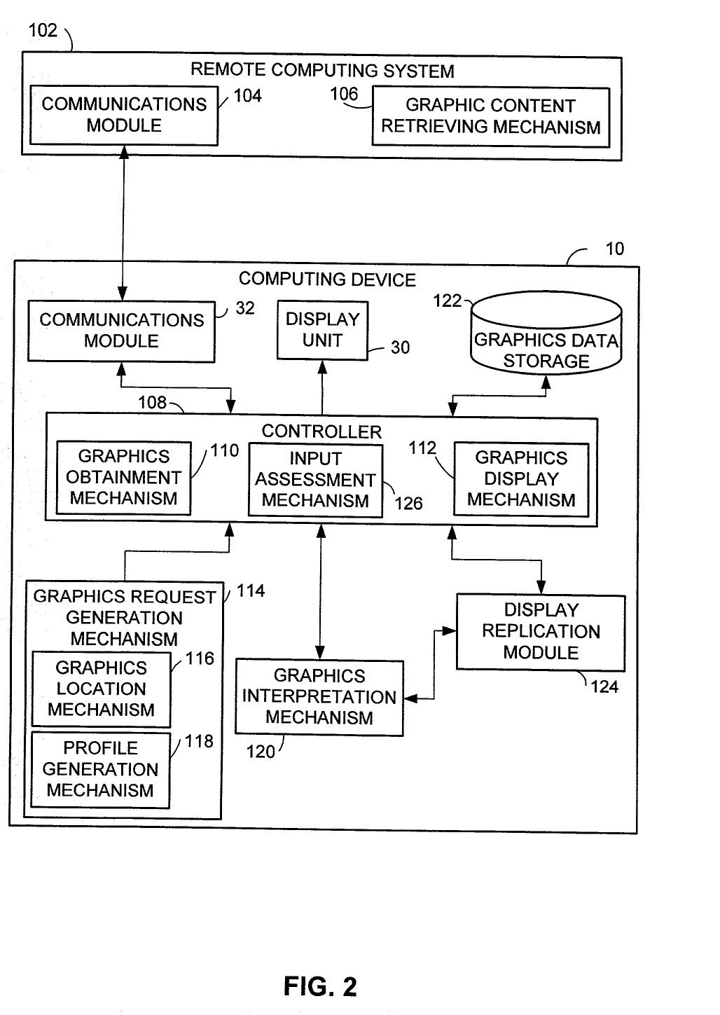

FIG. 2 shows the computing device 10 for displaying graphics information in communication with a remote computing system 102 from which the graphics information is received according to an embodiment of the present invention. The computing device 10 requests graphics information, such as text, icons and other images, graphic user interfaces, etc., from the remote computing system 102. A controller 108, a graphics interpretation mechanism 120, a display replication module 124, and a graphics data storage 122, all in the computing device 10, collectively interpret and adapt graphics information received from the remote computing system 102 for display on the display unit 30. Interpretation and adaptation involves converting the graphics information from a received format in which the graphics information is received to a processing format that enables adaptation of the graphics information into a display format that can be used for displaying the graphics information on the display unit 30.

The remote computing system 102 obtains graphics information for the computing device 10 based on a request therefrom. A communications module 104 facilitates communication between the remote computing system 102 and the computing device 10. A graphics content retrieving mechanism 106 retrieves graphics information indicated in the request received from the computing device 10. The graphics information may be stored in the remote computing system 102 or obtained from a separate graphics content system (not shown). The remote computing system 102 may be any device that provides or interfaces with a system that provides graphics information, such as the system disclosed in co-pending United States patent application titled “Method and System for Manipulating Graphics Information” filed concurrently herewith.

The computing device 10 includes the controller 108 for managing the obtainment and display of the graphics information, a graphics request generation mechanism 114 for producing a request for the graphics information, the communications module 32 for sending the request and receiving the graphics information, a graphics data storage 122 for storing the requested graphics information, a graphics interpretation mechanism 120 for construing the graphics information, a display replication module 124 for assisting in the conversion of the graphics information to the display format and the display unit 30 for displaying the graphics information. The graphics data storage 122 may be formed as part of the data storage device 34 or the program data 28. The controller 108 may be composed in a combination of the processing unit 12, the application program 24, other program modules 26 and the program data 28. The graphics request generation mechanism 114, the graphics interpretation mechanism 120 and the display replication module 124 may be embodied in various components such as the data storage device 34, the application program 24, other program modules 26 and the program data 28.

The computing device 10 receives an indication of graphics information that is to be displayed thereon. For example, a command may be received through the input device 36 indicating graphics information to be displayed. The controller 108 receives the input information containing an identification of the graphics information. The identification information may include an external source from which the graphics information can be obtained, such as the remote computing system 102, as well as an identifier for the graphics information.

The controller 108 includes a graphics obtainment mechanism 110, a graphics display mechanism 112 and an input assessment mechanism 126 that function together to manage the process of obtaining and displaying the identified graphics information. The input assessment mechanism 126 analyzes the input information to determine the type of command received, such as a request to display new graphics information or an adjustment (e.g. zoom, pan, scale, etc.) of currently displayed graphics information.

If the input information is a request to display the indicated graphics information then the input information is provided to the graphics obtainment mechanism 110. The graphics obtainment mechanism 110 may search the graphics data storage 122 to determine if the graphics information indicated in the input information was previously displayed and stored. If the graphics information is not found in the graphics data storage 122 then portions of the input information relevant to a request for the graphics information are provided to the graphics request generation mechanism 114 for request formulation. The portions of the input information relevant to the request may include a location of the source of the graphics information and the identifier for the graphics information.

The graphics request generation mechanism 114 includes a graphics location mechanism 116 and a profile generation mechanism 118 that create a request for graphics information including relevant identification of the computing device 10 and the requested graphics information. The graphics location mechanism 116 receives the relevant input information and determines the remote computing system 102 that is to be contacted to obtain the graphics information, the process by which the remote computing system 102 is to be contacted and the graphics information identifier. The remote computing system 102 location may be received from the input information and may be composed of one or more locations. Location information may additionally be stored in the graphics location mechanism 116 or the graphics data storage 122 in the case of predefined graphics information sources. For example, if the remote computing system 102 obtains the graphics information from another system, the location of the remote computing system 102 may be stored in the graphics location mechanism 116 or the graphics data storage 122 and the location of the other system may be contained in the input information. This would result in all requests being sent to the same location (i.e. the remote computing system) and an address for the other system being included in the request. The process by which the remote computing system 102 is to be contacted may also be stored in the graphics location mechanism 116 or the graphics data storage 122 or contained in the input information.

The identification information contained in the input information identifies the graphics information by, for example, file name(s). Once the relevant information for obtaining the graphics information has been determined, the graphics location mechanism 116 formats a request containing the relevant information that will be sent to the remote computing system 102.

The profile generation mechanism 118 creates a characterization of the capabilities of the computing device 10. The characterization of the computing device 10 may include information such as the type of the computing device 10, amount of memory, transmission speed, speed of the processing unit 12 and characteristics of the display unit 30, such as color capabilities, display size, display resolution, color depth, pixel aspect ratio, pixel pitch, bitmap representation to memory mapping, etc. Creation of the characterization or profile of the computing device 10 may be performed at initialization of the request generation mechanism 114 and stored in a data storage, such as the graphics data storage 122. Alternatively, or in conjunction with the above, the profile generation mechanism 118 may query different components of the computing device 10 for current characteristics, such as available memory, etc., to form the characterization. The characterization or profile is provided to the graphics obtainment mechanism 110 for inclusion in the request.

The completed request, including the characterization, is then provided to the communications module 32 for transmission to the remote computing device 102. The remote computing device 102 processes the request for the graphics information and provides the requested graphics information to the computing device 10. The graphics information from the remote computing device 102 is received by the communications module 32 and provided to the controller 108 where the graphics display mechanism 112 manages the process of displaying the received graphics information.

When the graphics information has been received or if the input information is a request to adjust currently displayed graphics information, the graphics display mechanism 112 orchestrates the process of converting the graphics information into the display format having the characteristics indicated in the input information or dictated by the characteristics of the display unit 30. The graphics display mechanism 112 may store the received graphics information in the graphics data storage 122. If the input information was a request to adjust the display characteristics then the graphics display mechanism 112 examines the graphics data storage 122 and the display replication module 124 to determine storage location(s) of the currently displayed graphics information. The graphics display mechanism 112 may obtain the currently displayed graphics information from the graphics data storage 122. The graphics information from the graphics data storage 122 is provided to the graphics interpretation mechanism 120 for manipulation into the processing format and the display format that is displayable on the display unit 30.

Alternatively, the currently displayed graphics information may have been retained in the display replication module 124 in the processing format. If this is the case, indication is provided to the graphics interpretation mechanism 120 from the graphics display device 112 that the graphics information in the display replication module 124 is to be manipulated and retrieved according to the adjustments indicated in the input information. The graphics display mechanism 112 may favor graphics information located in the display replication module 124 as the conversion to the processing format has been previously performed.

The manipulated graphics information is provided back to the graphics display mechanism 112 for display on the display unit 30. The manipulated graphics information may be stored in the graphics data storage 122 by the graphics display mechanism 112 for use in adapting the display characteristics of the graphics information.

The graphics data storage 122 may contain any graphics information recently received from the remote computing system 102 and graphics information that has been manipulated for display by the graphics interpretation mechanism 120. The information stored in the graphics data storage 122 may depend on the characteristics of the computing device 10. For example, if the computing device 10 has a small amount of memory then the manipulated graphics information may be stored in the graphics data storage 122 and then removed when other graphics information is requested. If recently received graphics information is not stored in the graphics data storage 122 then the graphics obtainment mechanism 110 will not search the data storage 122 for the graphics information.

The graphics interpretation mechanism 120 segments the received graphics information into its constituent objects, such as various geometric shapes (e.g. line, circle, polygon, etc.), complex effects (e.g. anti-aliasing, transparency, etc.), bitmaps and text. These constituent objects collectively represent the graphics information. The display replication module 124 is used to model the display unit 30 thus allowing the constituent objects to be relatively oriented and configured to represent the graphics information as it would be displayed. The constituent objects relatively oriented and configured in the display replication module 124 provide the graphics information in the processing format in a form suitable for conversion to the display format. The display replication module 124 can then be accessed by the graphics interpretation mechanism 120 to convert graphics information into the display format to be accepted and displayed by the display unit 30.

The display replication module 124 assists the graphics interpretation mechanism 120 with orienting and configuring the individual constituent objects to represent the graphics information. The graphics information in the display replication module 124 can then be accessed in a manner similar to that used by the display unit 30 to convert the graphics information into the display format.

The display replication module 124 may be composed of a grid of multiple elements, each element representing a display element in the display unit 30. The display replication module 124 may represent each object as a bitmap; thus, the processing format and the display format may be bitmap representations of the received graphics information.

The display elements of the display unit 30 are generally pixels. The pixels, and therefore each element in the display replication module 124, may be capable of representing black or white, various shades of grey, or a specific color for various colors palettes with each pixel or element being represented by larger numbers for more complex color systems. Each element in the display replication module 124 is of a consistent size (e.g. one byte, two bytes, or four bytes) regardless of the color complexity of the display unit 30. Thus, the display replication module 124 need not be concerned about the actual format of the graphics information as displayed on the display unit 30. Further, the display replication module 124 need not be limited in size by the size of the display unit 30. The manner in which objects are represented in the display replication module 124 may be independent of display capabilities of the computing device 10.

Conversion of size and/or color palette or any other characteristics of the display unit 30 may occur separately (e.g. during accessing of the display replication module 124 to form the display format). This allows the characteristics of the display replication module 124 to remain consistent regardless of the type of the computing device 10, which may have varying size, color palettes, pixel densities, etc. The display replication module 124 containing the graphics information in the processing format provides a simulation of the physical representation of the graphics information.

While FIG. 2 depicts a single remote computing system 102 in communication with the computing device 10, this is exemplary and the computing device 10 may communicate with multiple remote computing systems 102.

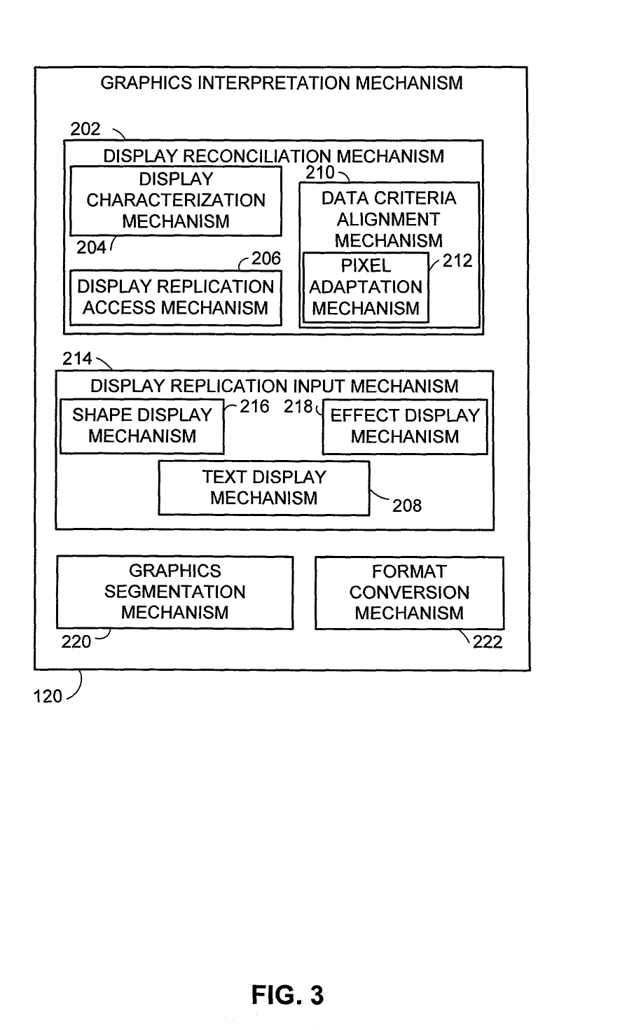

FIG. 3 shows a system diagram of the graphics interpretation mechanism 120 shown in FIG. 2. The graphics interpretation mechanism 120 converts the received graphics information from the received format to the processing format to the display format used to display the graphics information on the display unit 30. The graphics interpretation mechanism 120 includes a format conversion mechanism 222 for converting the graphics information from the received format to the processing format, a graphics segmentation mechanism 220 for breaking the graphics information into the constituent objects, a display replication input mechanism 214 for relatively orienting and configuring the constituent objects in the display replication module 124, and a display reconciliation mechanism 202 for accessing the display replication module 124 and manipulating the contents thereof to convert the graphics information into the display format.

The graphics segmentation mechanism 220 segments the graphics information into its constituent objects. The graphics information in the received format may be in a descriptive format and structured to provide easy segmentation (e.g. tree format with each branch representing a constituent object). In this format each individual object can be retrieved from the graphics information. Alternatively, the graphics segmentation mechanism 220 may create an abstract representation of the graphics information illustrating each entity with related display information as a constituent object and showing the relationships between the objects. For example, a circle and all information relating to the display of the circle, such as size, fill, line thickness, etc., may form a constituent object.

The format conversion mechanism 222 converts each constituent object into the processing format that is compatible with the format of the display replication module 124. The format conversion mechanism 222 converts the constituent objects from a descriptive representation to a displayable object. The processing format may represent each constituent object with elements that the display replication module 124 is composed of, for example, the processing format may be a bitmap representation. The processing format may be independent of the display capabilities of the computing device 10.

The display replication input mechanism 214 includes a shape display mechanism 216, an effect display mechanism 218 and a text display mechanism 208. The display replication input mechanism 214 provides the constituent objects in the processing format to the display replication module 124 and orients the objects relative to each other to reconstruct the graphics information as it would be displayed. Each display mechanism 216, 218, 208 determines whether or not a constituent element is to be displayed and generates those constituent elements that are to be displayed onto the display replication module 124. Constituent elements may not be displayed if they are too detailed to be correctly represented by the display unit 30, if they are too complex to be displayed, etc.

The shape display mechanism 216 generates shape constituent objects on the display replication module 124 for representation therein. Shape generation involves rasterizing the stroke (outline) and/or fill (inside) of the shape represented by the shape constituent object. Shapes can include lines, ellipses, polygons and other geometric shapes. Fills can be solid, patterns, transparent, gradient or other. The effect display mechanism 218 configures the contents of the display replication module 124 according to the complex effects constituent objects. The complex effects may include anti-aliasing, semi-transparency, clipping and other similar graphical techniques. The text display mechanism 208 provides constituent objects containing text for display to the display replication module 124. Text may be generated on the display replication module 124 in a manner similar to the generation of shapes.

The shape display mechanism 216, the effect display mechanism 218 and the text display mechanism 208 consider the display replication module 124 to be a display and “draw” the constituent objects onto the grid of the display replication module 124 accordingly. The “drawing” or generating of the constituent objects to the display replication module 124 involves the transformation of the graphics information from a descriptive representation to a rasterized representation, considering the displayable area to be the entire graphics representation. For example, a rectangle 3 pixels high by 5 pixels wide offset 2 pixels vertically and 2 pixels horizontally from the upper left corner of the display is <rect x=″2 pixels″ y=″2 pixels″ height=″3pixels″ width=″5 pixels″>in a descriptive representation. The rasterized representation of this same element for a monochrome display 8 pixels high by 16 pixels wide (each character represents a pixel where ‘0’=pixel is white and ‘1’=pixel is black) is:

┌0 ┌0 ┌0 ┌0 ┌0 ┌0 ┌0 ┌0 ┌0 ┌0 ┌0 ┌0 ┌0 ┌0 ┌0 ┌0
┌0 ┌0 ┌0 ┌0 ┌0 ┌0 ┌0 ┌0 ┌0 ┌0 ┌0 ┌0 ┌0 ┌0 ┌0 ┌0
┌0 ┌0 ┌0 ┌0 ┌0 ┌0 ┌0 ┌0 ┌0 ┌0 ┌0 ┌0 ┌0 ┌0 ┌0 ┌0
┌0 ┌0 ┌0 ┌0 ┌0 ┌0 ┌0 ┌0 ┌0 ┌0 ┌0 ┌0 ┌0 ┌0 ┌0 ┌0
┌0 ┌0 ┌0 ┌0 ┌0 ┌0 ┌0 ┌0 ┌0 ┌0 ┌0 ┌0 ┌0 ┌0 ┌0 ┌0
┌0 ┌0 ┌0 ┌0 ┌0 ┌0 ┌0 ┌0 ┌0 ┌0 ┌0 ┌0 ┌0 ┌0 ┌0 ┌0
┌0 ┌0 ┌0 ┌0 ┌0 ┌0 ┌0 ┌0 ┌0 ┌0 ┌0 ┌0 ┌0 ┌0 ┌0 ┌0
┌0 ┌0 ┌0 ┌0 ┌0 ┌0 ┌0 ┌0 ┌0 ┌0 ┌0 ┌0 ┌0 ┌0 ┌0 ┌0

The drawing, generating or rasterizing of the shapes, effects and text on to the display replication module 124 may be performed in accordance with known techniques for performing these functions.

The display reconciliation mechanism 202 is an access to the display replication module 124 for obtaining the contents thereof. The display reconciliation module 202 includes a display characterization mechanism 204, a display replication access mechanism 206, and a data criteria alignment mechanism 210 with a pixel adaptation mechanism 212. The display characterization mechanism 204 determines the characteristics of the display unit 30 to which the graphics information is to be conformed prior to display thereon. These characteristics may be derived from the computing device profile formed by the graphics request generation mechanism 114. Alternatively, if the input information was a request to adjust the display of the currently displayed graphics information then the characteristics may be determined from the requested adjustments, possibly in combination with the computing device profile. The display characterization mechanism 204 creates a set of criteria from the display characteristics to which the graphics information obtained from the display replication module 124 is conformed. The criteria may include adjustments in color representation, text display, size, coordinate systems indicating element location, element density or resolution and the ordering and storage of information for each element.

The data criteria alignment mechanism 210 manipulates the contents of the display replication module 124 to conform to the set of criteria determined by the display characterization mechanism 204. The set of criteria may be applied to the graphics information before, after and/or during accessing of the display replication module 124. The data criteria alignment mechanism 210 determines a series of manipulations to be performed on the graphics information to conform the graphics information to the set of criteria. Each manipulation in the series may include a desirable stage for implementation (e.g. before, after or during display replication module 124 accessing). Those manipulations that are to be performed before accessing the display replication module 124 may be directly applied to the contents of the module 124 by the data criteria alignment mechanism 2 10. Manipulations that are to be performed during accessing of the display replication module 124 are provided to the display replication access mechanism 206.

As the display replication module 124 is independent of the characteristics of the display unit 30, the contents may be adjusted to provide new displayable graphics information by performing such frictions as scroll, pan and zoom, without necessarily requiring re-processing of the graphics information to the processing format. These functions can be accomplished by re-transforming and re-converting the contents of the display replication module 124 specifying different display characteristics.

The display replication access mechanism 206 retrieves the contents of the display replication module 124 according to a scheme used by the display unit 30 to interpret and display graphics information. Details regarding the display replication module 124 access scheme may be set out in one or a number of manipulations that are to be performed during accessing. As the display replication access mechanism 206 retrieves the contents of the display replication module 124, a particular order and size may be used, indicated by the provided manipulations. The order in which each element in the display replication module 124 is accessed may be dependent on the type of the display unit 30. For example, on Research In Motion™ devices a byte not only represent 8 pixels but the eight pixels are assumed to be oriented vertically on the display of the device. Thus, retrieval of a column versus a row from the grid of the display replication module 124 may be dependent on the type of the computing device 10. Also during the retrieval, the display replication access mechanism 206 may take into account the viewable area of the display unit 30 and retrieve only the portion of the display replication module 124 that would be viewable on the display unit 30. The viewable area may be specified in a manipulation by a size and a location.

The display replication access mechanism 206 also stores the retrieved graphics information from the display replication module 124 for further manipulation before display on the display unit 30. The format in which the retrieved graphics information is stored may be dependent on the format the display unit 30 expects. Some display units 30 expect that pixel information will be packed into data elements (e.g. octets, words, etc.) that span columns and/or row boundaries. Thus, as the contents of the display replication module 124 is retrieved according to a specified order, this information may also be stored in a specified format (e.g. information form eight elements stored in one byte). Conversion of the retrieved graphics information to a different storage format may alternatively occur after the initial storage and other manipulations have been performed.

After the contents of the display replication module 124 have been retrieved by the display replication access mechanism 206 they are provided to the data criteria alignment mechanism 210 for implementation of the remaining manipulations. This may involve the conversion of the color representation, conversion of the text display, conversion of the element density or resolution and, if not previously performed, conversion of the storage format. Conversion of the color representation may involve a simplification of colors, such as a conversion from a 24-bit true color system to a greyscale color representation. Simplification of the color representation may be required prior to converting the storage format. Conversion of the text display may involve positioning the text to ensure visibility/readability in combination with other manipulations. Conversion of the element density or resolution is performed by the pixel adaptation mechanism 212 to conform the size of each element in the retrieved graphics information to the size of each pixel in the display unit 30. This may involve sampling or averaging groups of pixels, thus reducing the resolution of the retrieved graphics information. The conversion may be performed according to any of a number of techniques known in the art.

After the conversions have been performed the graphics information is in the display format and is provided to the graphics display mechanism 112 of the controller 108 for display on the display unit 30.

The display reconciliation mechanism 202 may be specific for the type of computing device 10. This allows the graphics interpretation mechanism 120 to be customized for each type of computing device by replacement of only one component (i.e. the display reconciliation mechanism 202).

It will be understood that various embodiments of the present invention support different sub-sets of the above mentioned functionality incorporated into the computing device 10. The functions included are reflective of the intended target application, available memory and processing capacity of the processing unit 12 of the computing device 10 as well as other similar consideration. In this manner the functions of displaying graphics information on the computing device 10 may be provided in a scalable implementation.

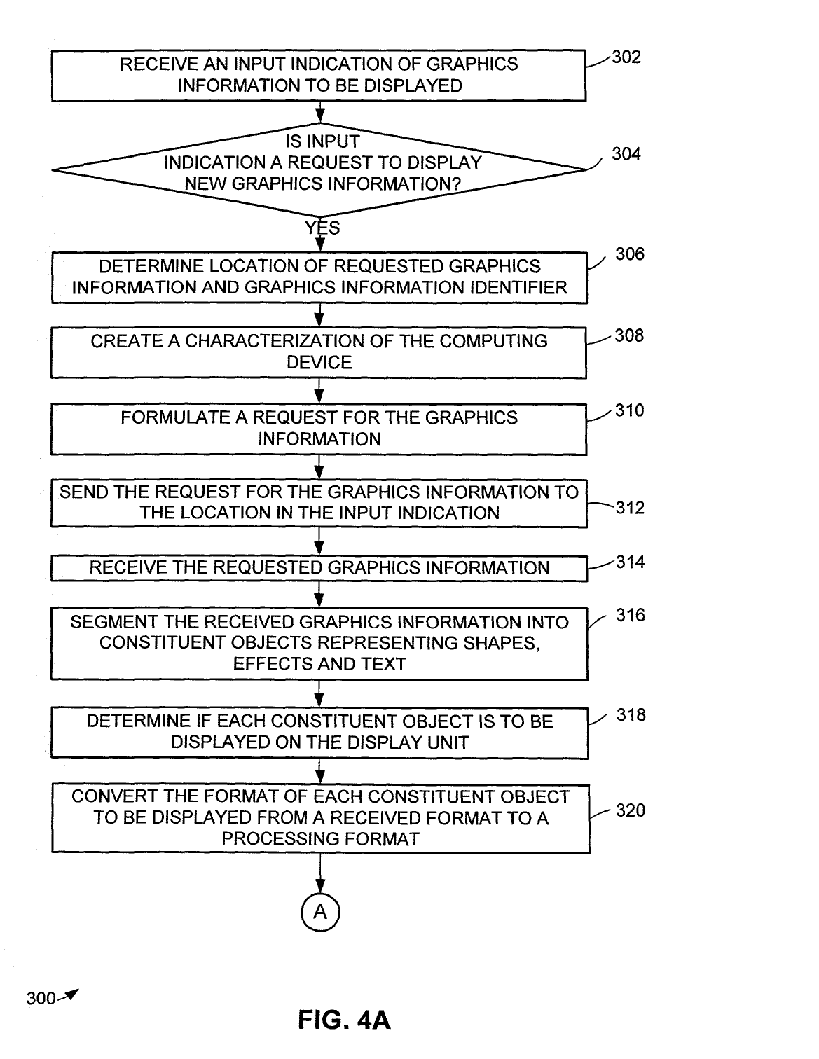

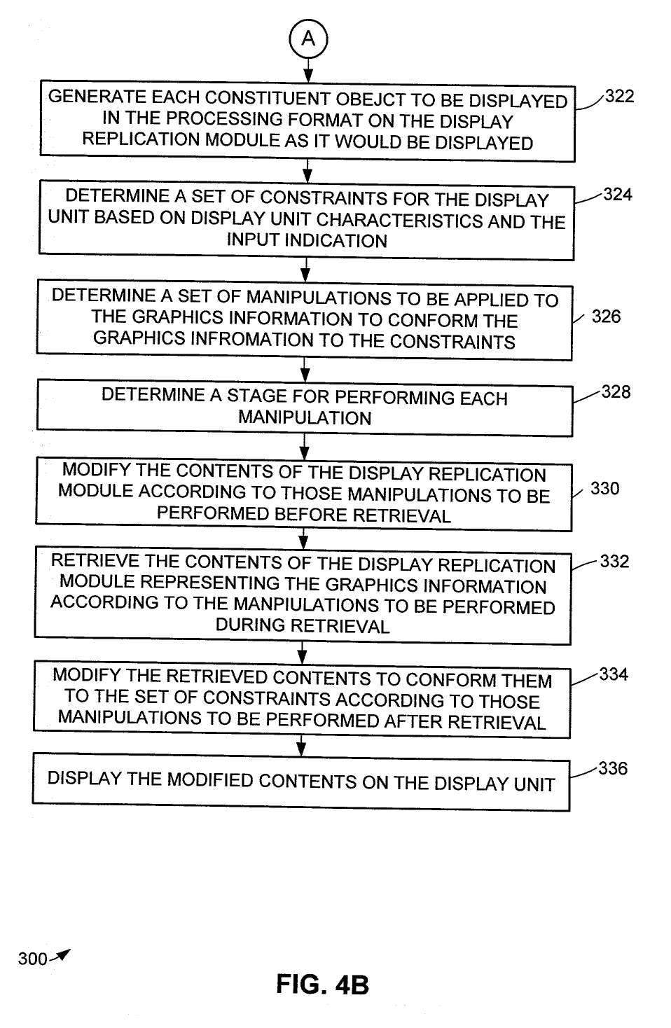

FIGS. 4A and B depicts a flow chart illustrating a method 300 of obtaining and displaying graphics information on the display unit 30 of the computing device 10 according to an embodiment of the present invention. An indication is received by the controller 108 that graphics information is to be displayed, step 302. This indication may be the result of a request to display new graphics information or a request to display currently displayed graphics information with adjustment display characteristics. The input indication includes the type of request as well as any other pertinent information such as the adjustments to make, or where to obtain the graphics information.

The type of request is determined in step 304. If the request is to display new graphics information then the location of the graphics information and the graphics information identifier are determined from the input indication in step 306.

A characterization of the computing device 10 is created in step 308. This characterization includes information about the processing capabilities, communications capabilities, storage capabilities and the display capabilities.

A request is formulated from the graphics information location and identifier and the computing device characterization in step 310. This request is sent to the location indicated in the input indication in step 312. The requested graphics information is then received in step 314.

The received graphics information is segmented into its constituent objects in step 316. The constituent objects may represent individual shapes, complex effects and text as well as any related display information for each of these elements. Those constituent objects that are to be displayed is determined in step 318. If the display unit 30 of the computing device 10 is unable to accommodate the display of complex effects, etc. due to characteristics of the display unit 30 (e.g. display size, pixel size or resolution, etc.) then certain constituent objects may be removed from the graphics information.

Each constituent object that will be displayed on the display unit 30 is converted from the received format, which is generally descriptive (e.g. scalable vector graphics—SVG), to the processing format, which is generally rasterized (e.g. bitmap). Each constituent object is then generated on the display replication module 124 in step 322. Generation of each constituent object involves applying the object in the processing format to the grid of the display replication module 124 and relatively orienting each object to replicate the graphics information as it would be displayed.

A set of constraints for the display unit 30 is determined based on the characterization of the computing device 10 and the input indication in step 324. If the request in the input indication was for an adjustment of currently displayed graphics information then the indicated adjustments are included in the set of constraints. A set of manipulations that will conform the graphics information in the display replication module 124 to the set of constraints is developed in step 326. For each of these manipulations a stage for performance is determined relative to retrieval of the contents of the display replication module 124 (e.g. before, after or during) in step 328.

The contents of the display replication module 124 are modified according to those manipulations that are to be performed before retrieval in step 330. The contents of the display replication module 124 are then retrieved according to the manipulations to be performed during retrieval in step 332. After the contents of the display replication module 124 have been retrieved those manipulations that are to be performed after are applied in step 334. The results of these manipulations converts the graphics information in the processing format into the display format. The graphics information is then displayed on the display unit 30 in step 336.

It is apparent to one skilled in the art that numerous modifications and departures from the specific embodiments described herein may be made without departing from the spirit and scope of the invention.

1. A method of modifying graphics information for display on a computing device having a set of display characteristics representing display capabilities of the computing device, said method comprising:
generating the graphics information to a display replication module to provide the graphics information in a processing format; and
obtaining the graphics information in the processing format from said display replication module according to an access scheme based on the set of display characteristics to convert the graphics information into a display format suitable for display on the computing device.

2. The method according to claim 1 further including:
segmenting the graphics information into a plurality of graphic elements prior to generating the graphics information to said display replication module, each of said plurality of graphic elements representing a displayable characteristic from the graphics information;
and wherein the step of generating includes:
generating each of said plurality of graphic elements to said display replication module to replicate the graphics information in the processing format.

3. The method according to claim 1 further including:
requesting the graphics information from a graphics data storage prior to generating the graphics information to said display replication module.

4. The method according to claim 3 wherein the step of requesting includes:
creating the set of display characteristics of the computing device based on display capabilities of the computing device; and
providing a request to said graphics data storage, said request containing the set of display characteristics and an identifier for the graphics information.

5. The method according to claim 2 wherein the step of segmenting includes:
determining relationships between each of said plurality of graphic elements, said plurality of graphic elements arranged according to said determined relationships forming a representation of the graphics information.

6. The method according to claim 5 wherein the step of generating includes:
converting each of said plurality of graphic elements from the first format to the processing format; and
arranging each of said plurality of graphic elements in the processing format in said display replication module according to said determined relationships.

7. The method according to claim 1 wherein the step of obtaining includes:
determining a set of constraints for the computing device based on the set of display characteristics; and
determining a set of manipulations to conform the graphics information in the processing format to the set of constraints, said set of manipulations forming said access scheme.

8. The method according to claim 7 wherein the step of obtaining further includes:
retrieving the graphics information in the processing format from said display replication module based on said access scheme.

9. The method according to claim 1 further including:
displaying the graphics information in the display format on the computing device.

10. The method according to claim 1 wherein said display replication module has a set of defining characteristics, said set of defining characteristics being independent of the set of display characteristics of the computing device, and wherein the processing format is independent of the display format.

11. A method of modifying graphics information for display on a computing device having a set of display characteristics representing display capabilities of the computing device, said method comprising:
segmenting the graphics information into a plurality of graphic elements, each of said plurality of graphic elements representing a displayable characteristic from the graphics information;
generating each of said plurality of graphic elements to a display replication module to provide the graphics information in a processing format; and
obtaining the graphics information in the processing format from said display replication module according to an access scheme based on the set of display characteristics to convert the graphics information into a display format suitable for display on the computing device.

12. The method according to claim 11 further including:
requesting the graphics information from a graphics data storage prior to segmenting the graphics information.

13. The method according to claim 12 wherein the step of requesting includes:
creating the set of display characteristics of the computing device based capabilities of the computing device; and
providing a request to said graphics data storage, said request the set of display characteristics and an identifier for the graphics information.

14. The method according to claim 11 wherein the step of segmenting includes:
determining relationships between each of said plurality of graphic elements, said plurality of graphic elements arranged according to said determined relationships forming a representation of the graphics information.

15. The method according to claim 11 wherein the step of generating includes:
converting each of said plurality of graphic elements to the processing format; and
arranging each of said plurality of graphic elements in the processing format in said display replication module according to said determined relationships.

16. The method according to claim 11 wherein the step of obtaining includes:
determining a set of constraints for the computing device based on the set of display characteristics; and
determining a set of manipulations to conform the graphics information in the processing format to the set of constraints, said set of manipulations forming said access scheme.

17. The method according to claim 16 wherein the step of obtaining further includes:
retrieving the graphics information in the processing format from said display replication module based on said access scheme.

18. The method according to claim 11 further including:
displaying the graphics information in the display format on the computing device.

19. The method according to claim 11 wherein said display replication module has a set of defining characteristics, said set of defining characteristics being independent of the set of display characteristics of the computing device, and wherein the processing format is independent of the display format.

20. A system for modifying graphics information for display on a computing device having a set of display characteristics representing display capabilities of the computing device, said system comprising:
a display replication module for retaining the graphics information in a processing format that is interpretable by the computing device;
an interpretation mechanism for generating the graphics information to said display replication module to provide the graphics information in the second format;
a module access mechanism for obtaining the graphics information in the processing format from said display replication module according to an access scheme based on the set of display characteristics to provide graphics information in a display format adapted for display on the computing device; and
a controller for orchestrating conversion of the graphics to the processing format and the display format.

21. The system according to claim 20 further including:
a segment mechanism for segmenting the graphics information into a plurality of graphic elements and determining relationships between each of said plurality of graphic elements, each of said plurality of graphic elements representing a displayable characteristic from the graphics information, wherein said plurality of graphic elements arranged according to said determined relationships represents the graphics information; and
wherein said interpretation mechanism generates said plurality of graphic elements to said display replication module.

22. The system according to claim 20 further including:
an interface to a graphics data storage for holding the graphics information; and
a request generation mechanism for providing a request for the graphics information to said graphics data storage, said request including an identifier for the graphics information.

23. The system according to claim 22 wherein said request generation mechanism includes:
a characteristic set mechanism for creating the set of display characteristics of the computing device based on display capabilities of the computing device, the set of display characteristics being provided to said graphics data storage with said request.

24. The system according to claim 21 wherein said interpretation mechanism includes:
a format conversion mechanism for converting each of said plurality of graphic elements to the processing format; and
a graphics replication mechanism for arranging each of said plurality of graphic elements in the processing format in said display replication module according to said determined relationships.

25. The system according to claim 20 wherein said module access mechanism includes:
a characterization mechanism for determining a set of constraints for the computing device based on the set of display characteristics; and
an manipulation determination mechanism for determining a set of manipulations to conform the graphics information in the processing format to the set of constraints, said set of manipulations forming said access scheme.

26. The system according to claim 25 wherein said module access mechanism further includes:
a retrieval mechanism for retrieving the graphics information in the processing format from the display replication module based on said access scheme.

27. The system according to claim 20 further including:
a display presentation mechanism for providing the graphics information in the display format for display on the computing device.

28. The system according to claim 20 wherein said display replication module has a set of defining characteristics, said set of defining characteristics being independent of the set of display characteristics of the computing device, and wherein the processing format is independent of the display format.

29. A computer readable medium having stored thereon computer-executable instructions for modifying graphics information for display on a computing device having a set of display characteristics representing display capabilities of the computing device, said computer-executable instructions comprising:
generating the graphics information to a display replication module to provide the graphics information in a processing format; and
obtaining the graphics information in the processing format from said display replication module according to an access scheme based on the set of display characteristics to convert the graphics information into a display format suitable for display on the computing device.

30. The computer-executable instructions according to claim 28 further including:
segmenting the graphics information into a plurality of graphic elements prior to generating the graphics information to said display replication module, each of said plurality of graphic elements representing a displayable characteristic from the graphics information;
and wherein the step of generating includes:
generating each of said plurality of graphic elements to said display replication module to replicate the graphics information in the processing format.

31. The computer-executable instructions according to claim 28 further including:
requesting the graphics information from a graphics data storage prior to generating the graphics information to said display replication module.

32. The computer-executable instructions according to claim 31 wherein the step of requesting includes:
creating the set of display characteristics of the computing device based on display capabilities of the computing device; and
providing a request to said graphics data storage, said request containing the set of display characteristics and an identifier for the graphics information.

33. The computer executable instructions according to claim 30 wherein the step of segmenting includes:
determining relationships between each of said plurality of graphic elements, said plurality of graphic elements arranged according to said determined relationships forming a representation of the graphics information.

34. The computer-executable instructions according to claim 33 wherein the step of generating includes:
converting each of said plurality of graphic elements from the first format to the processing format; and
arranging each of said plurality of graphic elements in the processing format in said display replication module according to said determined relationships.

35. The computer-executable instructions according to claim 28 wherein the step of obtaining includes:
determining a set of constraints for the computing device based on the set of display characteristics; and
determining a set of manipulations to conform the graphics information in the processing format to the set of constraints, said set of manipulations forming said access scheme.

36. The computer-executable instructions according to claim 35 wherein the step of obtaining further includes:
retrieving the graphics information in the processing format from said display replication module based on said access scheme.

37. The computer-executable instructions according to claim 28 further including:
displaying the graphics information in the display format on the computing device.

38. The computer-executable instructions according to claim 28 wherein said display replication module has a set of defining characteristics, said set of defining characteristics being independent of the set of display characteristics of the computing device, and wherein the processing format is independent of the display format.

39. A computer readable medium having stored thereon computer-executable instructions for modifying graphics information for display on a computing device having a set of display characteristics representing display capabilities of the computing device, said computer-executable instructions comprising:
segmenting the graphics information into a plurality of graphic elements, each of said plurality of graphic elements representing a displayable characteristic from the graphics information;
generating each of said plurality of graphic elements to a display replication module to provide the graphics information in a processing format; and
obtaining the graphics information in the processing format from said display replication module according to an access scheme based on the set of display characteristics to convert the graphics information into a display format suitable for display on the computing device.

40. The computer-executable instructions according to claim 39 further including:
requesting the graphics information from a graphics data storage prior to segmenting the graphics information.

41. The computer-executable instructions according to claim 40 wherein the step of requesting includes:
creating the set of display characteristics of the computing device based on display capabilities of the computing device; and
providing a request to said graphics data storage, said request the set of display characteristics and an identifier for the graphics information.

42. The computer-executable instructions according to claim 39 wherein the step of segmenting includes:
determining relationships between each of said plurality of graphic elements, said plurality of graphic elements arranged according to said determined relationships forming a representation of the graphics information.

43. The computer-executable instructions according to claim 39 wherein the step of generating includes:
converting each of said plurality of graphic elements from the first format to the processing format; and
arranging each of said plurality of graphic elements in the processing format in said display replication module according to said determined relationships.

44. The computer-executable instructions according to claim 39 wherein the step of obtaining includes:
determining a set of constraints for the computing device based on the set of display characteristics; and
determining a set of manipulations to conform the graphics information in the processing format to the set of constraints, said set of manipulations forming said access scheme.

45. The computer-executable instructions according to claim 44 wherein the step of obtaining further includes:
retrieving the graphics information in the processing format from said display replication module based on said access scheme.

46. The computer-executable instructions according to claim 39 further including:
displaying the graphics information in the display format on the computing device.

47. The computer-executable instructions according to claim 39 wherein said display replication module has a set of defining characteristics, said set of defining characteristics being independent of the set of display characteristics of the computing device, and wherein the processing format is independent of the display format.
